(19) United States
(12) Patent Application Publication
(10) Pub. No.: US 2004/0122179 A1
(43) Pub. Date: Jun. 24, 2004

(54) Structures providing low absorbing polymers at 157 nm wavelengths

(76) Inventors: Christopher K. Ober, Ithaca, NY (US); Vaishali R. Vohra, Ithaca, NY (US)

Correspondence Address: ERIC S. SPECTOR, BACON & THOMAS, PLLC, 625 SLATERS LANE, FOURTH FLOOR, ALEXANDRIA, VA, 22314, US

(21) Appl. No.: 10/327,652

(22) Filed: Dec. 24, 2002

(51) Int. Cl. C08F 259/00

(52) U.S. Cl. 525/276

(57) ABSTRACT

Monomers containing two or more hexafluoroisopropyl groups and containing plural saturated rings are polymerized to form polymers of high transparency optical properties at 157 nm wavelengths and improved etch resistance compared to polymers formed from single ring monomers.

### TECHNICAL FIELD

The invention is directed to monomers, which are polymerizable to form photoresists for 157 nm lithography.

### BACKGROUND OF THE INVENTION

Optical lithography at 248 nm or 193 nm wavelengths requires resolution enhancement techniques for high resolution small feature sizes for integrated circuits.

Use of shorter exposure wavelengths to avoid complexities involved in resolution enhancement techniques, is now being considered.

With recent improvements in laser technology and optical materials, optical lithography at 157 nm using an F₂ excimer laser light source has emerged as the current choice for post-193-nm technology in the fabrication of devices with features sizes less than 100 nm.

A single-layer photoresist process for imaging at 157 nm is favored among potential industry consumers.

Potential materials for use in a single layer photoresist must offer high transparency at exposure wavelength, resistance to plasma etching processes, and the ability to undergo efficient photochemical transformations that change their solubility in developer solution.

It has been previously discovered that structures containing two or more hexafluoroisopropyl (HFIP) groups can be used to functionialize methacrylate, acrylate and styrenic monomers and that the functionalized monomers will form polymers of low optical absorbance at 157 nm wavelengths. This was reported in Bae, Y. C., et al, Polymer Preprints 42 (2), 403-404 (2001) and Bae, Y. C., et al, Chem. Mater. 14, 1306-1313 (Jan. 31, 2002) where the syntheses are disclosed of 2-[4-(2-hydroxyhexafluoroisopropyl)cyclohexane]hexafluoroisopropyl acrylate, 2-[4-(2,2,2-trifluoro-1-methoxymethoxy-1-trifluoromethylethyl)cyclohexane]hexafluoroisopropyl acrylate and 2-[4-(2,2,2-trifluoro-1-ethoxymethoxy-1-trifluoromethylethyl)] styrene. These materials have limited etch resistance.

### SUMMARY OF THE INVENTION

It has been discovered herein that monomers can be prepared that can be polymerized to form polymers of similar high transparency optical properties at 157 nm wavelengths and improved etch resistance. It has been discovered that by a unique combination of elements providing such monomers comprise 2 or more hexafluoroisopropyl (HFIP) groups and 2 or more rings.

One embodiment of the invention herein that meets such advantage, denoted the first embodiment, is a composition having the structure

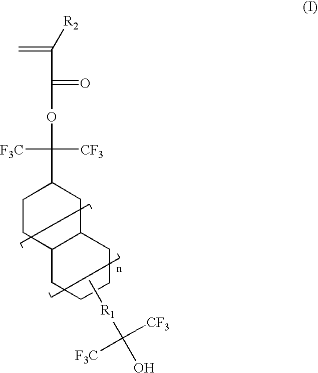

where n is 0, 1 or 2, R₁ is selected from the group consisting of cyclohexylene, cyclohexyl ether and hexafluoroisopropyl cyclohexyl or is not present and R₂ is selected from the group consisting of hydrogen, fluorine and chlorine atoms and methyl and trifluoromethyl groups, with the proviso that when n=0, the structure (I) contains at least two rings; or a composition having the structure

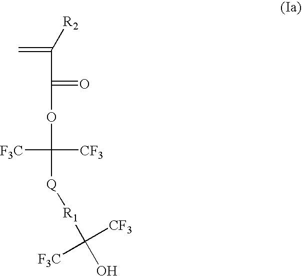

where R₁ and R₂ are as defined previously and Q is selected from the group consisting of

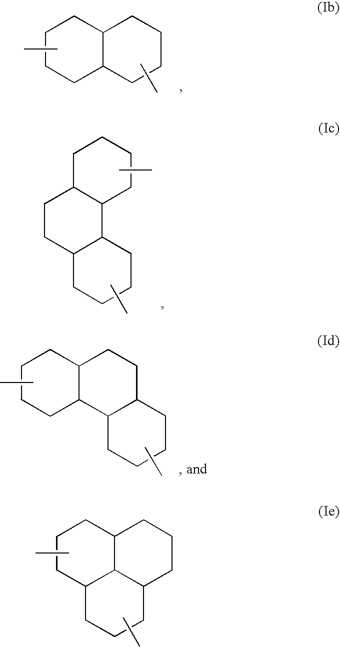

Another embodiment of the invention herein, denoted the second embodiment, is directed to composition having the structure

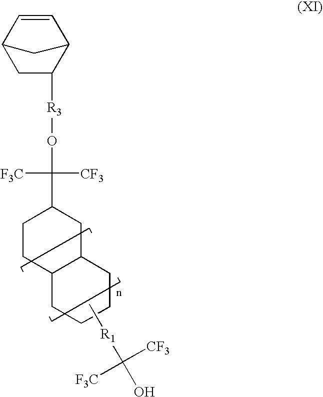

where n is 0, 1 or 2, R₁ is selected from the group consisting of cyclohexylene, cyclohexyl ether and hexafluoroisopropyl cyclohexyl or is not present and R₃ is CO or is not present; or a composition having the structure

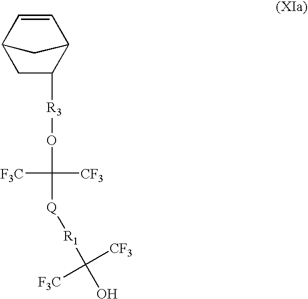

where R₁ and R₃ are as defined previously and Q is selected from the group consisting of

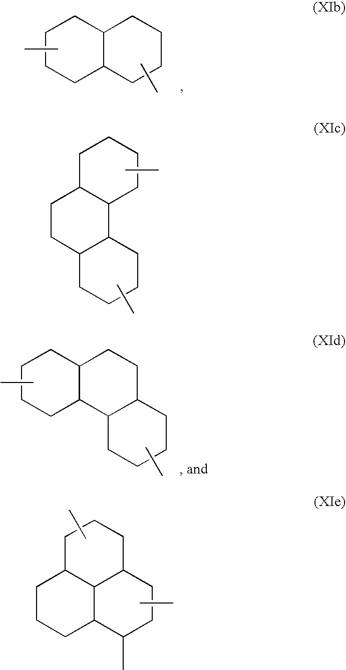

Starting materials for structures (Ib), (Ic), (Id), (Ie), (XIb), (XIc), (XId) and (XIe) are commercially available or given this disclosure can be synthesized by those skilled in the art.

For the first and second embodiments when R₁ is cyclohexyl ether, the ether group can attach to any carbon in the ring to which it is shown bonding to, which is not a bridgehead carbon.

For the first and second embodiments for the cases with Q, R₁ and hexafluoroisopropyl moiety can attach to any carbon in the ring to which it is shown bonding to, which is not a bridgehead carbon.

Another embodiment herein, denoted the third embodiment is directed at low absorbing polymer at 157 nm wavelengths having the structure

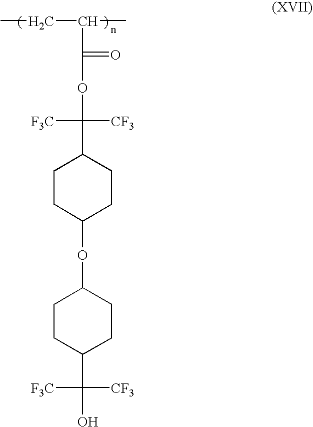

where n ranges from 4 to 30.

As used herein, the term methyl means —CH₃.

As used herein, the term “trifluoromethyl” means —CF₃.

As used herein, the terms “low absorbance” and “low-optical absorbance” both mean the same and mean absorbance at 157 nm at less than 3.00 μm⁻¹.

As used herein, the term “high transparency optical properties at 157 nm wavelengths” means absorbing at 157 nm at less than 3.00 μm⁻¹.

### DETAILED DESCRIPTION

We turn now to the first embodiment herein, that is compounds of the structure (I) as described above.

In general these compounds are made by starting with plural unsaturated ring precursors, e.g., containing biphenyl or naphthalene or anthracene moieties and two or more hexafluoroisopropyl groups and hydroxy group on hexafluoroisopropyl (HFIP) group, and hydrogenating, e.g., using a supported rhodium catalyst, to form aliphatic low absorbance ring groups coupled to the HFIP groups and then reacting hydroxy with acryloyl, methacryloyl, α-trifluoromethyl acryloyl, 2-fluoroacryloyl or 2-chloroacryloyl chloride in tetrahydrofuran or dichloromethane, and hydrolyzing by the addition of water.

A subgenus of these compounds where R₁ is cyclohexyl ether, has the structure

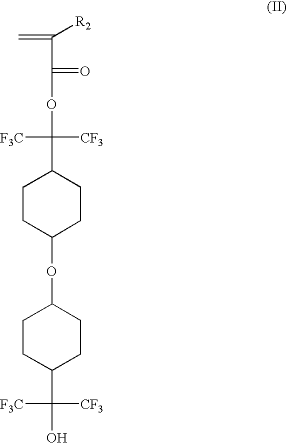

where R₂ is selected from the group consisting of hydrogen, fluorine and chlorine atoms and methyl and trifluoromethyl groups. The starting material for these compounds is 4,4′-bis(2-hydroxyhexafluoroisopropyl) diphenyl ether (which is commercially available), which is hydrogenated to produce 1,1,1,3,3,3-hexafluoro-2-{4-[-(2,2,2-trifluoro-1-hydroxy-1-trifluoromethyl-ethyl)-cyclohexyloxy]cyclohexyl}-propan-2-ol, which is reacted with acryloyl chloride or substituted acryloyl chloride, followed by hydrolysis, to produce a compound (II).

One compound of the subgenus (II) has the structure

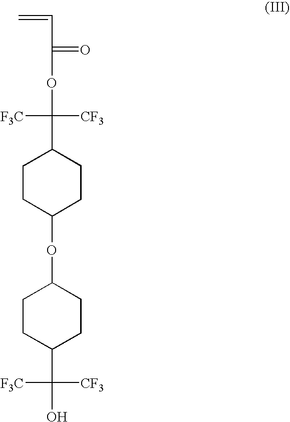

This compound is prepared in working Example I hereinafter.

A subgenus of the compound (I) where R₁ is cyclohexyl, has the structure

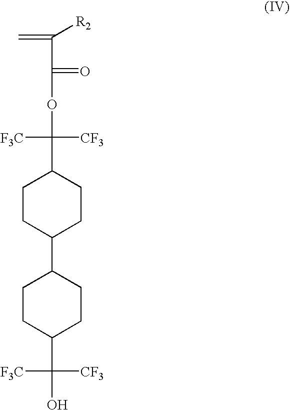

where R₂ is selected from the group consisting of hydrogen, fluorine and chlorine atoms and methyl and trifluoromethyl groups. A hydrogenation product starting material for producing compounds (IV) is 1,1,1,3,3,3-hexafluoro-2-[4′-(2,2,2-trifluoro-1-hydroxy-1-trifluoromethyl-ethyl)-bicyclohexyl-4-yl]-propan-2-ol which is reacted with acryloyl chloride or substituted acryloyl chloride, followed by hydrolysis, to produce a compound (IV). The hydrogenation product starting material is made from the commercially available starting material 4,4′-bis(2-hydroxyhexafluoroisopropyl)diphenyl by hydrogenation as described in working Example I.

One compound of subgenus (IV) has the structure

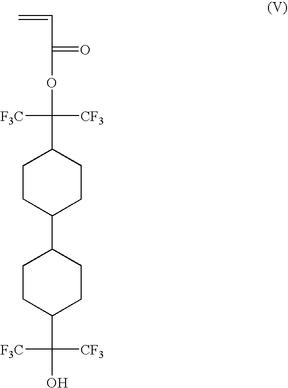

This compound is prepared in working Example II hereinafter.

A subgenus of the compounds (I) where R₁ is hexafluoroisopropyl cyclohexyl has the structure

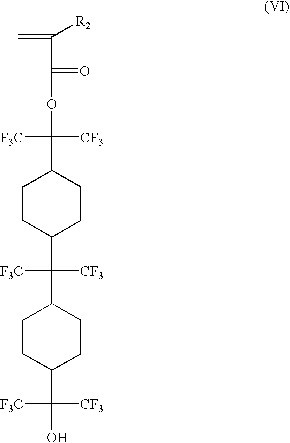

where R₂ is selected from the group consisting of hydrogen, fluorine and chlorine atoms and methyl and trifluoromethyl groups. A hydrogenation product starting material for producing compounds (VI) is 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl ethyl}-cyclohexyl]-propan-2-ol which is reacted with acryloyl chloride or substituted acryloyl chloride, followed by hydrolysis, to produce a compound (VI). The hydrogenation product starting material is made from the commercially available starting material 1,1,1,3,3,3-hexafluoro-2-[4′-{2,2,2-trifluoro-1-[4-(2,2,2-trifluoro-1-hydroxy-1-trifluoromethyl-ethyl)phenyl]-1-trifluoromethyl-ethyl}-phenyl]-propan-2-ol by hydrogenation as described in working Example I.

One compound of subgenus (VI) has the structure

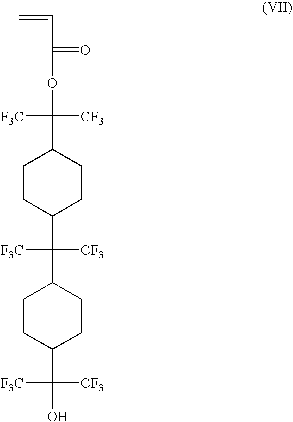

This compound is prepared in working Example III hereinafter.

A subgenus of the compounds (I) where R₁ is not present and n=1 has the structure

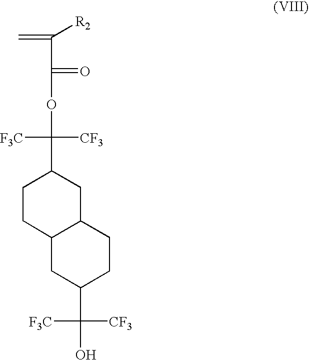

where R₂ is selected from the group consisting of hydrogen, fluorine and chlorine atoms and methyl and trifluoromethyl groups. A hydrogenation product starting material for producing compounds (VIII) is 1,1,1,3,3,3-hexafluoro-2-[6-(2,2,2-trifluoro-1-hydroxy-1-trifluoromethyl-ethyl)-decahydro-naphthalen-2-yl]-propan-2-ol which is reacted with acryloyl chloride or substituted acryloyl chloride, followed by hydrolysis, to produce a compound (VIII). The hydrogenation product starting material is made from the starting material 1,1,1,3,3,3-hexafluoro-2-[6-(2,2,2-trifluoro-1-hydroxy-1-trifluoromethyl-ethyl)-naphthalen-2-yl]-propan-2-ol by hydrogenation as described in working Example I. The starting material which is subjected to hydrogenation is prepared from the commercially available starting materials 2,6-dibromonaphthalene and hexafluoroacetone under Grignard Reaction conditions to give the corresponding tertiary alcohol.

One compound of subgenus (VIII) has the structure

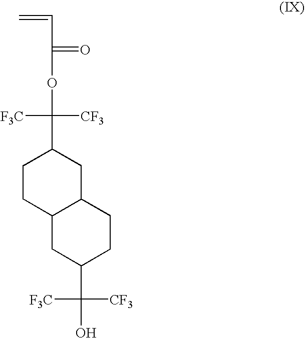

This compound is prepared in working example IV hereinafter.

A subgenus of the compound (I) where R₁ is not present and n=2 has the structure

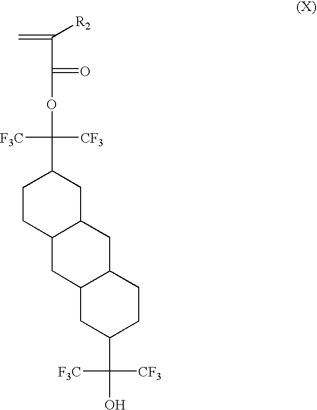

where R₂ is selected from the group consisting of hydrogen, fluorine and chlorine atoms and methyl and trifluoromethyl groups. A hydrogenation product starting material for producing compounds (X) is 1,1,1,3,3,3-hexafluoro-2-[6-(2,2,2-trifluoro-1-hydroxy-1-trifluoromethyl-ethyl)-tetradecahydro-anthracen-2-yl]-propan-2-ol which is reacted with acryloyl chloride or substituted acryloyl chloride, followed by hydrolysis, to produce a compound (X). The hydrogenation product starting material is made from the starting material 1,1,1,3,3,3-hexafluoro-2-[6-(2,2,2-trifluoro-1-hydroxy-1-trifluoromethyl-ethyl)-anthracene-2-yl]-propan-2-ol by hydrogenation as described in working Example I. Thee starting material which is subjected to hydrogenation is prepared from the commercially available starting materials 2,6-dibromoanthracene and hexafluoroacetone under Grignard Reaction conditions to give the corresponding tertiary alcohol.

The compounds (I) can be polymerized to form polymers of low optical absorbance at 157 nm wavelengths and good etch resistance in the presence of a catalyst for vinyl polymerization, e.g., 2,2′-azobisisobutyronitrile (AIBN) in tetrahydrofuran (THF) e.g., at 60-70° C.

We turn now to the second embodiment herein, that is compounds of the structure (XI) as described above.

In general, compounds (XI), where R₃ is CO, are made starting with unsaturated ring precursor and two or more hexafluoroisopropyl groups and hydroxy group on hexafluoroisopropyl (HFIP) group, and hydrogenating, e.g., using a supported rhodium catalyst, to form aliphatic low absorbance ring group(s) coupled to HFIP groups and then reacting hydrogenation product, e.g., hydrogenated diol, with bicyclo[2.2.1]hept-5-ene-2-carbonyl chloride in the presence of n-butyllithium in tetrahydrofuran and hydrolyzing by the addition of water, to replace hydrogen on hydroxy with bicyclo[2.2.1]hept-5-ene-2-carbonyl.

In general compounds (XI) where R₃ is not present are made as described in the above paragraph except substituting 5-chlorobicyclo[2.2.1]hept-2-ene for the bicyclo[2.2.2]hept-5-ene-2-carbonyl chloride.

One compound embraced by genus (XI), where R₃ is CO and R₁ is not present and n=0, has the structure

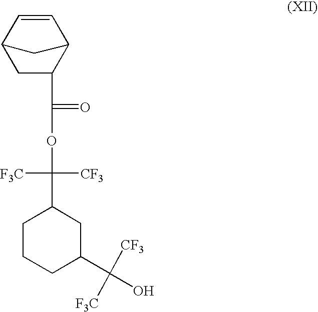

A hydrogenation product starting material for producing compound (XII) is 1,1,1,3,3,3-hexafluoro-2-[3-(2,2,2-trifluoro-1-hydroxy-1-trifluoromethyl-ethyl)-cyclohexyl]-propan-2-ol, which is reacted with bicyclo[2.2.1]hept-5-ene-2-carbonyl chloride in the presence of butyllithuim in tetrahydrofuran, followed by hydrolysis by addition of water, to produce compound (XII). The hydrogenation product starting material is made from the commercially available starting material 1,1,1,3,3,3-hexafluoro-2-[3-(2,2,2-trifluoro-1-hydroxy-1-trifluoromethyl-ethyl)-phenyl]-propan-2-ol by hydrogenation as described in working Example I. The compound (XII) is prepared in working Example XXVI hereinafter.

Another compound embraced by genus (XI), where R₃ is CO and R₁ is not present and n=1, has the structure

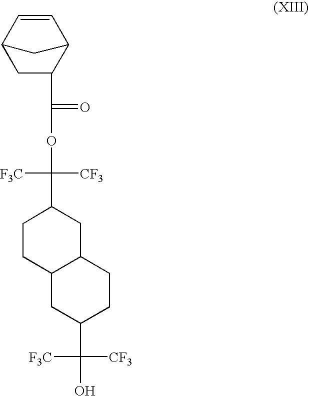

A hydrogenation product starting material for producing compound (XIII) is 1,1,1,3,3,3-hexafluoro-[6-(2,2,2-trifluoro-1-hydroxy-1-trifluoromethyl-ethyl)-decahydro-naphthalen-2-yl]-propan-2-ol which is reacted with bicyclo[2.2.1]hept-5-ene-2-carbonyl chloride in the presence of n-butyllithium in tetrahydrofuran, followed by hydrolysis by the addition of water, to produce compound (XIII). The hydrogenation product starting material is made from the same commercially available starting materials as compounds (VIII) by hydrogenation as described in working Example I. The compound (XIII) is prepared in working Example XXVII hereinafter.

Still another compound embraced by genus (XI), where R₃ is CO and R₁ is not present and n=2, has the structure

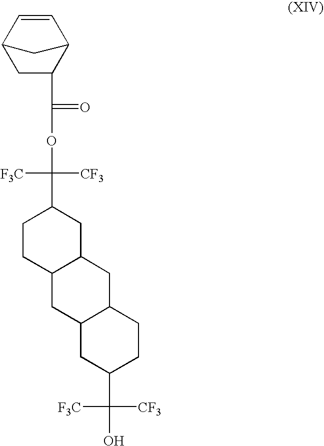

A hydrogenation product starting material for producing compound (XIV) is 1,1,1,3,3,3-hexafluoro-2-[6-(2,2,2-trifluoro-1-hydroxy-1-trifluoromethyl-ethyl)-tetradecahydro-anthracen-2-yl]-propan-2-ol which is reacted with bicyclo[2.2.1]hept-5-ene-2-carbonyl chloride in the presence of n-butyllithium in tetrahydrofuran, followed by hydrolysis by the addition of water, to produce compound (XIV). The hydrogenation product starting material is made from the same commercially available starting materials as compounds (X) by hydrogenation as described in working Example I. The compound (XIV) is prepared in working Example XXVIII hereinafter.

Yet another compound embraced by genus (XI), where R₃ is CO, R₁ is cyclohexyl ether and n=0, has the structure

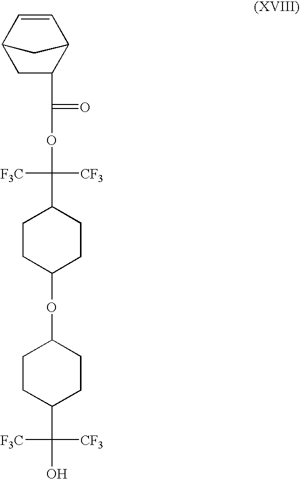

Hydrogenation product starting material for producing compound (XVIII) is 1,1,1,3,3,3-hexafluoro-2-{4′-[-(2,2,2-trifluoro-1-hydroxy-1-trifluoromethylethyl)-cyclohexyloxy]cyclohexyl}-propan-2-ol which is reacted with bicyclo[2.2.1]hept-5-ene-2-carbonyl chloride in the presence of n-butyllithium in tetrahydrofuran, followed by hydrolysis by the addition of water, to produce compound (XVIII). The hydrogenation product starting material is made as described in working Example I. The compound (XVIII) is prepared in working Example XXIX hereinafter.

Yet another compound embraced by genus (XI), where R₃ is CO and R₁ is cyclohexyl and n=0, has the structure

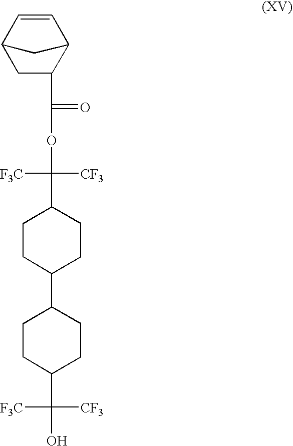

A hydrogenation product starting material for producing compound (XV) is 1,1,1,3,3,3-hexafluoro-2-[4′-(2,2,2-trifluoro-1-hydroxy-1-trifluoromethyl-ethyl)-bicylohexyl-4-yl]-propan-2-ol which is reacted with bicyclo[2.2.1]hept-5-ene-2-carbonyl chloride in the presence of n-butyllithium in tetrahydrofuran, followed by hydrolysis by the addition of water, to produce compound (XV). The hydrogenation product starting material is made from the same commercially available starting materials as compounds (IV) by hydrogenating as described in working Example I. The compound is prepared in working Example XXX hereinafter.

Yet another compound embraced by genus (XI), where R₃ is CO, R₁ is hexafluoroisopropyl cyclohexyl and n=0, has the structure

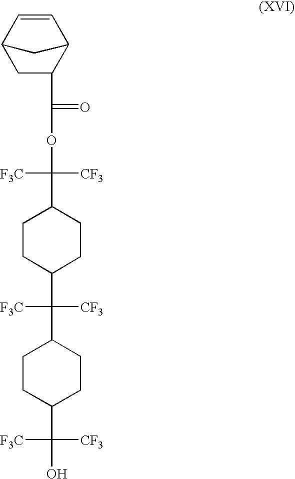

Hydrogenation product starting material for producing compound (XVI) is 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol which is reacted with bicyclo[2.2.1]hept-5-ene-2-carbonyl chloride in the presence of n-butyllithium in tetrahydrofuran, followed by hydrolysis by the addition of water, to produce compound (XVI). The hydrogenation product starting material is made from the same starting material as compounds (VI) by hydrogenation as described in working Example I. The compound (XVI) is prepared in working Example XXXI hereinafter.

The compounds (XI) are polymerized to form low absorbing polymers at 157 nm wavelengths by metal-catalyzed polymerization. The norbornene ring does not open on polymerization but becomes saturated and joins another ring monomer which becomes saturated.

We turn now to the third embodiment herein, that is the low absorbing polymer at 157 nm wavelength having the structure

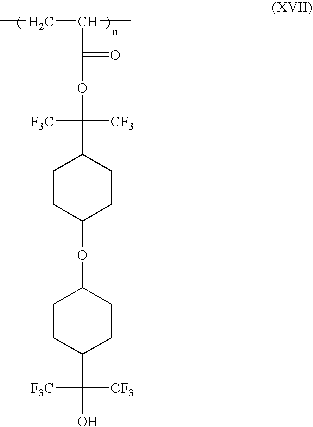

where n ranges from 4 to 30. This is prepared by polymerizing compound (III) in the presence of 2,2′-azobisisobutyronitrile in tetrahydrofuran at 60-70° C. A polymer (XVII) where n=7 is prepared in working Example XXXIII hereinafter.

Imaging at 157 nm can be carried out using an Exitech 157 nm Microstepper (NA=0.6, σ=0.7). Polymers are dissolved in propylene glycol methyl ether acetate (PGMEA). The resist solution is filtered through a 0.2 μm membrane filter and spin-coated onto silicon wafers that are either primed with HMDS gas or treated with anti-reflective coatings. Post-apply bake and post-exposure bake can be carried out at 90-130° C. and development can be conducted in 0.262 N tetramethyl ammonium hydroxide solution.

Absorbance at 157 nm can be recorded on a VU-301 vacuum ultraviolet variable angle spectroscopic ellipsometer (VUV-VASE) instrument.

Etch resistance can be measured by using a Plasma Therm 72 RIE system which is a 10-inch diameter parallel plate, molecular turbo-pumped system which is microprocessor controlled and gives 5% uniformity and applies fluorine based plasma including CHF₃, SF₆ and CF₄ for anisotropic etching of silicon, silicon dioxide and silicon nitride and operates at 10-1000 um processing pressure.

The invention is illustrated by the following working examples.

### EXAMPLE I

### Synthesis of Compound (III)

1,1,1,3,3,3-Hexafluoro-2-{4′-[-(2,2,2-trifluoro-1-hydroxy-1-trifluoromethyl-ethyl)-cyclohexyloxy]cyclohexyl}-propan-2-ol was prepared by hydrogenation of 4,4′-bis(2-hydroxyhexafluoroisopropyl)diphenyl ether using a supported rhodium catalyst (5 wt % on carbon powder). Using this Scheme, 47% yield was obtained on the basis of diol and the separated products by column chromatography included 52.2 mol % of monoacrylate, 15.5 mol % of diacrylate and 32.3 mol % of diol. To a solution of 1,1,1,3,3,3-hexafluoro-2{4′-[-2,2,2-trifluoro-1-hydroxy-1-trifluoromethyl-ethyl)-cyclohexyloxyl}cyclohexyl}-propan-2-ol (5 g, 0.0097 mol) in dry tetrahydrofuran (THF), was added 6.1 mL of 1.6 M n-butyllithium (0.0097 mol) under nitrogen during 30 minutes by dropwise addition of acryloyl chloride (0.88 g, 0.0097 mol) dissolved in dry THF. The resulting solution was stirred overnight at room temperature and hydrolyzed by the addition of distilled water. The aqueous phase was extracted with ethyl ether, and the combined organic phase was dried over MgSO₄. The crude product was purified by column chromatography (49% yield). ¹H NMR (CDCl₃, 400 MHz) δ 6.51(1H, CHHₜᵣₐₙₛ═CH—), 6.12 (1H, CH₂—CH—), 5.98(CHH_{cis}═CH—), 3.6 (1H, methine H, adjacent to ester), 3.2 (2H, methine H, adjacent to ether), 3.0-3.1 (1H, methine H, adjacent to hydroxyl and 1H, —OH), 1.2-2.1 (methylene H in the rings).

### EXAMPLE II

### Synthesis of Compound V

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry THF, is added n-butyllithium (1 equivalent) under nitrogen during 30 minutes followed by dropwise addition of acryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE III

### Synthesis of Compound (VII)

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol in dry THF, is added n-butyllithium (1 equivalent) under nitrogen during 30 minutes followed by dropwise addition of acryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE IV

### Synthesis of Compound (IX)

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry THF, is added n-butyllithium (1 equivalent) under nitrogen during 30 minutes followed by dropwise addition of acryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE V

### Synthesis of Compound (VIII) Where R₂ is Methyl

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry THF, is added n-butyllithium (1 equivalent) under nitrogen during 30 minutes followed by dropwise addition of methacryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE VI

### Synthesis of Compound (VIII) Where R₂ is Trifluoromethyl

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of α-trifluoromethyl acryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE VII

### Synthesis of Compound (VIII) Where R₂ is a Fluorine Atom

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of fluoroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE VIII

### Synthesis of Compound (VIII) Where R₇ is a Chlorine Atom

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of 2-chloroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE IX

### Synthesis of Compound (X) Where R₂ is a Hydrogen Atom

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in THF, is added n-butyllithium (1 equivalent) under nitrogen during 30 minutes followed by dropwise addition of acryloyl chloride (1 equivalent) dissolved in dry THF. The resulting solution is stirred overnight at room temperature and hydrolyzed by the addition of distilled water. The aqueous phase is extracted with ethyl ether and the combined organic phase is dried over MgSO₄. The crude product is purified by column chromatography.

### EXAMPLE X

### Synthesis of Compound (X) Where R₂ is a Methyl

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in dry THF, is added n-butyllithium (1 equivalent) under nitrogen during 30 minutes followed by dropwise addition of methacryloyl chloride (1 equivalent) dissolved in dry THF. The resulting solution is stirred overnight at rom temperature and hydrolyzed by the addition of distilled water. The aqueous phase is extracted with ethyl ether and the combined organic phase is dried over MgSO₄. The crude product is purified by column chromatography.

### EXAMPLE XI

### Synthesis of Compound (X) Where R₂ is a Trifluoromethyl

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in dry dichloromethane (DCM) is added 1 equivalent of freshly distilled triethylamine (in dry DCM) under nitrogen over a period of 30 minutes at 0° C. After 1 h, the resulting solution is treated with 2.4 g of α-trifluoromethyl acryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XII

### Synthesis of Compound (X) Where R₂ is a Fluorine Atom

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in dry dichloromethane (DCM) is added 1 equivalent of freshly distilled triethylamine (in dry DCM) under nitrogen over a period of 30 minutes at 0° C. After 1 h, the resulting solution is treated with 2.4 g of 2-fluoroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XIII

### Synthesis of Compound (X) Where R₂ is a Chlorine Atom

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in dry dichloromethane (DCM) is added 1 equivalent of freshly distilled triethylamine (in dry DCM) under nitrogen over a period of 30 minutes at 0° C. After 1 h, the resulting solution is treated with 2.4 g of chloroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XIV

### Synthesis of Compound (IV) Where R₂ is Methyl

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry THF, is added n-butyllithium (1 equivalent) under nitrogen during 30 minutes followed by dropwise addition of methacryloyl chloride (1 equivalent) dissolved in dry THF. The resulting solution is stirred overnight at room temperature and hydrolyzed by the addition of distilled water. The aqueous phase is extracted with ethyl ether and the combined organic phase is dried over MgSO₄. The crude product is purified by column chromatography.

### EXAMPLE XV

### Synthesis of Compound (IV) Where R₂ is Trifluoromethyl

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of α-trifluoromethyl acryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XVI

### Synthesis of Compound (IV) Where R₂ is Fluorine Atom

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of fluoroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XVII

### Synthesis of Compound (IV) Where R₂ is Chlorine Atom

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of chloroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XVIII

### Synthesis of Compound (II) Where R₂ is Methyl

To a solution of 1,1,1,3,3,3-hexafluoro-2-{4′-[(2,2,2-trifluoro-1-hydroxy-1-trifluoromethyl-ethyl)-cyclohexyloxy]cyclohexyl}-propan-2-ol in dry THF, is added n-butyllithium (1 equivalent) under nitrogen during 30 minutes followed by dropwise addition of methacryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XIX

### Synthesis of Compound (II) Where R₂ is Trifluoromethyl

To a solution of 1,1,1,3,3,3-hexafluoro-2-{4′-[(2,2,2-trifluoro-1-hydroxy-1-trifluoromethyl-ethyl)-cyclohexyloxy]cyclohexyl}-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of α-trifluoromethyl acryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XX

### Synthesis of Compound (II) Where R₂ is a Fluorine Atom

To a solution of 1,1,1,3,3,3-hexafluoro-2-{4′-[(2,2,2-trifluoro-1-hydroxy-1-trifluoromethyl-ethyl)-cyclohexyloxy]cyclohexyl}-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of fluoroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XXI

### Synthesis of Compound (II) Where R₂ is a Chlorine Atom

To a solution of 1,1,1,3,3,3-hexafluoro-2-{4′-[(2,2,2-trifluoro-1-hydroxy-1-trifluoromethyl-ethyl)-cyclohexyloxy]cyclohexyl}-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of chloroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XXII

### Synthesis of Compound (VI) Where R₂ is Methyl

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol in dry THF, is added n-butyllithium (1 equivalent) under nitrogen during 30 minutes followed by dropwise addition of methacryloyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXIII

### Synthesis of Compound (VI) Where R₂ is Trifluoromethyl

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of α-trifluoromethyl acryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XXIV

### Synthesis of Compound (VI) Where R₂ is a Fluorine Atom

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of fluoroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XXV

### Synthesis of Compound (VI) Where R₂ is a Chlorine Atom

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-1-cyclohexyl]-propan-2-ol in dry dichloromethane (DCM) is added 1 equivalent of freshly distilled triethylamine (in dry DCM) under nitrogen over a period of 30 min at 0° C. After 1 h, the resulting solution is treated with 2.4 g of chloroacryloyl chloride dissolved in 5 mL dry DCM over 30 min at 0° C. The resulting solution is stirred overnight at room temperature and hydrolyzed by the addition of 50 mL of distilled water. The aqueous phase is extracted with ethyl ether and the combined organic phase is dried over MgSO₄. The crude product is purified by column chromatography.

### EXAMPLE XXVI

### Synthesis of Compound (XII)

To a solution of 1,1,1,3,3,3-hexafluoro-2-[3-(2,2,2-trifluoro-1-hydroxy-1-trifluoromethyl-ethyl)-cyclohexyl]-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXVII

### Synthesis of Compound (XIII)

To a solution of 1,1,1,3,3,3-hexafluoro-2-[6-(2,2,2-trifluoro-1-hydroxy-1-trifluoromethyl-ethyl)-decahydro-naphthalen-2-yl]-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXVIII

### Synthesis of Compound (XIV)

To a solution of 1,1,1,3,3,3-hexafluoro-2-[6-(2,2,2-trifluoro-1-hydroxy-1-trifluoromethyl-ethyl)-tetradecahydro-anthracen-2-yl]-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXIX

### Synthesis of Compound (XVIII)

To a solution of 1,1,1,3,3,3-hexafluoro-2-{4′-[(2,2,2-trifluoro-1-hydroxy-1-trifluoromethyl-ethyl)-cyclohexyloxy]cyclohexyl}-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXX

### Synthesis of Compound (XV)

To a solution of 1,1,1,3,3,3-hexafluoro-2-[4′-(2,2,2-trifluoro-1-hydroxy-1-trifluoromethyl-ethyl)-bicyclohexyl-4-yl]-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXXI

### Synthesis of Compound (XVI)

To a solution of 1,1,1,3,3,3-hexafluoro-2-[4′-{2,2,2-trifluoro-1-[4-(2,2,2-trifluoro-1-hydroxy-1-trifluoromethyl-ethyl)-cyclohexyl]-1-trifluoromethyl-ethyl}-cyclohexyl]-propan-2-ol in dry THF, is added n-butyllithium (1 equivalent) under nitrogen during 30 minutes followed by dropwise addition of bicyclo[2.2.1]hept-5-ene-2-carbonyl chloride (1 equivalent) dissolved in dry THF. The resulting solution is stirred overnight at room temperature and hydrolyzed by the addition of distilled water. The aqueous phase is extracted with ethyl ether, and the combined organic phase is dried over MgSO₄. The crude product is purified by column chromatography.

### EXAMPLE XXXII

### Synthesis of Compounds (Ia) and (XIa) Where R₁ Not Present and Hexafluoroisopropyl Attaches at Various Carbons

Preparation of bis(2-hydroxyhexafluoroisopropyl)maphthalene:

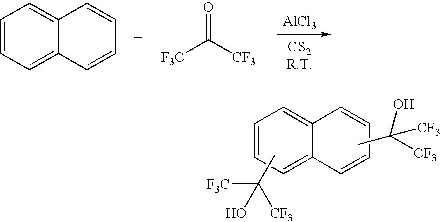

Naphthalene (12 g. 93.7 mmol), aluminum chloride (2 g. 15 mmol), and 50 mL of carbon disulfide were charged to a 300 mL Parr reactor in a dry box. This was then connected to a metal vacuum line and the reactor cooled with a dry ice-acetone bath. The line and the head space of the reactor were evacuated. The bath was removed and the temperature brought up to room temperature. Hexafluoroacetone was condensed in 20 to 30 psi increments (total of 200 psi, 182 mmol). There was a very slow pressure drop and no temperature increase. Addition of hexafluoroacetone took three days. Unreacted hexafluoroacetone was purged into a 5M sodium hydroxide solution and the reaction mixture was added to 200 mL of water. The two phases were separated and the aqueous layer further extracted with chloroform. The combined organic layer was dried over magnesium sulfate, filtered and the solvent evaporated in vacuo. Analysis (GC/MS) showed clean reaction with several isomers present. The product was purified by column chromatography on silica gel with elution using hexane, followed by 1:5 ethyl acetate:hexane, and characterized by GC/MS and NMR. Results show that the sample contains two major and three minor isomers.

Preparation of bis(2-hydroxyhexafluoroisopropyl)decalin:

A short path distillation was performed on 22 g. of bis(2-hydroxyhexafluoroisopropyl)naphthalene at 102-105° C. and 0.04 torr to give 15 g of clear white very viscous oil.

Into a one liter stainless steel Parr autoclave was placed 15 g. of the above naphthalene material, 12.1 g of 4% Rh on alumina (Engelhard) and 500 mL of isopropanol. After nitrogen and hydrogen purging, the reactor was put under 476 psig of hydrogen and heated to 100° C. and the hydrogen pressure adjusted to 800 psig. The reaction was allowed to proceed for 600 minutes. At that time GC/MS analysis revealed that a small amount of material was incompletely hydrogenated. The reaction was allowed to proceed an additional 800 minutes. A sample analyzed at this time revealed no additional hydrogenation had occurred. The reactor contents were cooled, filtered and concentrated in vacuo and then submitted to a short path distillation at 100-104° C. and 0.04 torr to give 13.3 g of a clear colorless liquid. The isomers of bis(2-hydroxyhexafluoroisopropyl)decalin were confirmed by GC/MS. The absence of any aromaticity was confirmed by ¹³CNMR; however, approximately 4 mole percent of a material containing a quaternary olefin was observed.

Preparation of (Ia) and (XIa):

The isomers with or without separation from each other are reacted with acryloyl chloride or bicyclo[2.2.2]hept-5-ene-2-carbonyl chloride or 5-chlorobicyclo[2.2.1]hept-2-ene.

### EXAMPLE XXXIII

### Synthesis of Polymer (XVII)

To a 25 mL Schlenk flask was added the monomer (III), 2,2′-azobisisobutyronitrile (1 mol % to monomer) and anhydrous tetrahydrofuran (30% solution in v/v). The reaction was degassed by the freeze-thaw method (3 times), sealed under nitrogen, and then immersed into an oil bath thermostated at 65° C. After 24 hours polymer was obtained by precipitating in methanol and drying in vacuum. The polymer obtained had the structure (XVII) where n=7. The absorbance at 157 nm was measured to be 2.4 μm⁻¹.

Variations

Many variations will be obvious to those skilled in the art. Therefore the invention is defined by the claims.

What is claimed is:

1. Composition having the structure 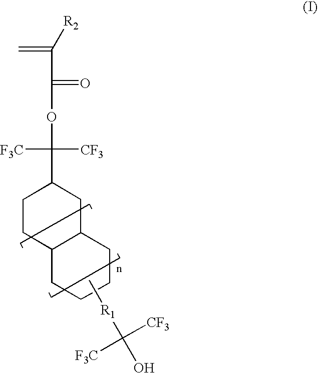
where n is 0, 1 or 2, R₁ is selected from the group consisting of cyclohexylene, cyclohexyl ether, and hexafluoroisopropyl cyclohexyl or is not present and R₂ is selected from the group consisting of hydrogen, fluorine and chlorine atoms and methyl and trifluoromethyl groups, with the proviso that when n=0 the structure (I) contains at least two rings; or a composition having the structure 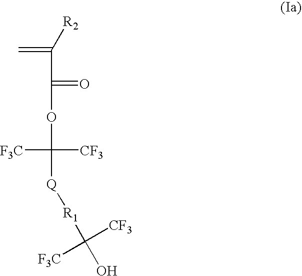
where R₁ and R₂ are as defined previously and Q is selected from the group consisting of

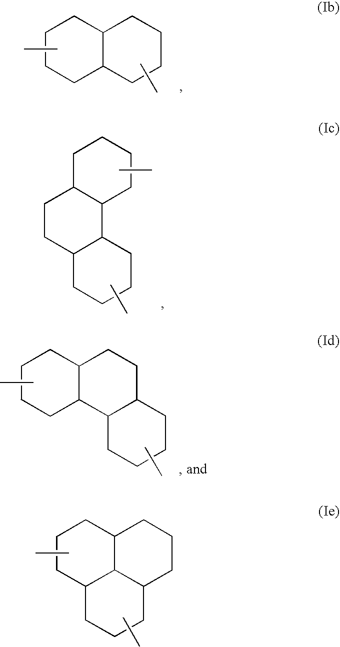

2. Composition according to claim 1 having the structure 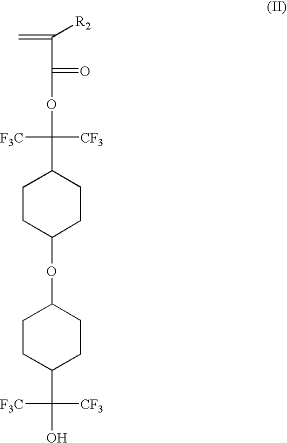
where R₂ is selected from the group consisting of hydrogen, fluorine and chlorine atoms and methyl and trifluoromethyl groups.

3. Composition according to claim 2 having the structure

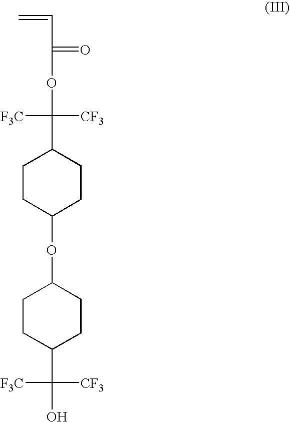

4. Composition according to claim 1 having the structure 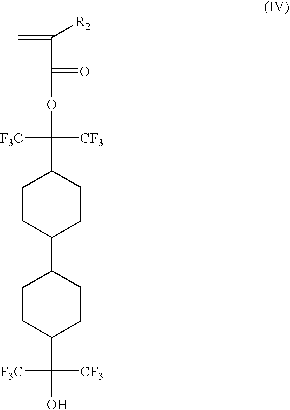
where R₂ is selected from the group consisting of hydrogen, fluorine and chlorine atoms and methyl and trifluoromethyl groups.

5. Composition according to claim 4 having the structure

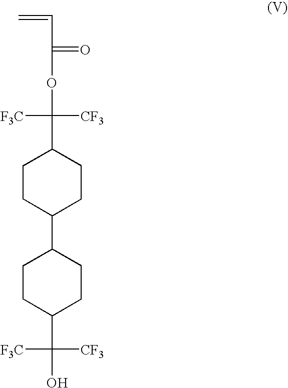

6. Composition according to claim 1 having the structure 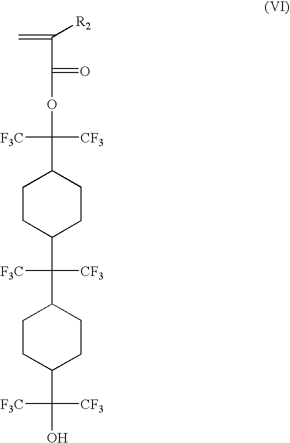
where R₂ is selected from the group consisting of hydrogen, fluorine and chlorine atoms and methyl and trifluoromethyl groups.

7. Composition according to claim 6 having the structure

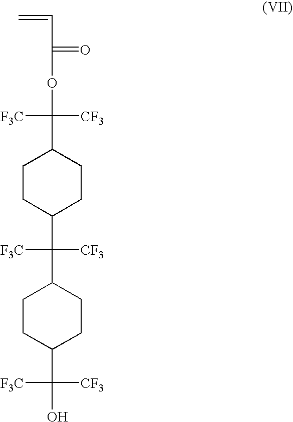

8. Composition according to claim 1 having the structure 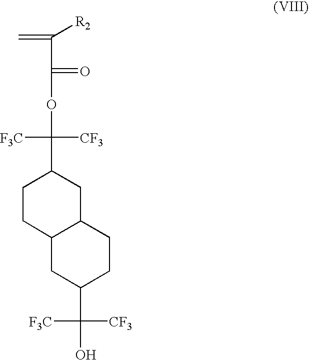
where R₂ is selected from the group consisting of hydrogen, fluorine and chlorine atoms and methyl and trifluoromethyl groups.

9. Composition according to claim 8 having the structure

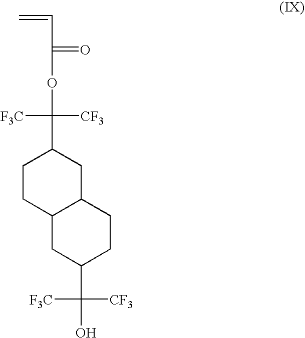

10. Composition according to claim 1 having the structure 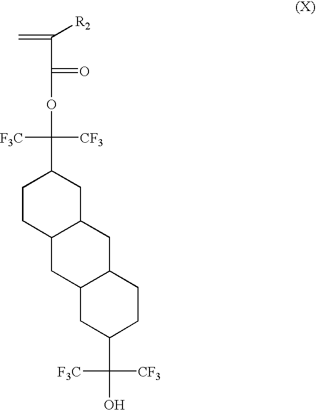
wherein R₂ is selected from the group consisting of hydrogen, fluorine and chlorine atoms and methyl and trifluoromethyl groups.

11. Composition having the structure 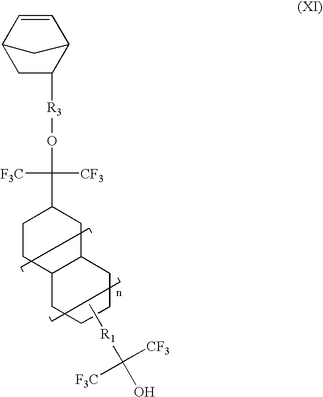
where n is 0, or 2, R₁ is selected from the group consisting of cyclohexylene, cyclohexyl ether, and hexafluoroisopropyl cyclohexyl or is not present, and R₃ is CO or is not present; or a composition having the structure 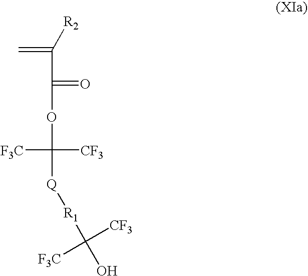
where R₁ and R₃ are as defined previously and Q is selected from the group consisting of

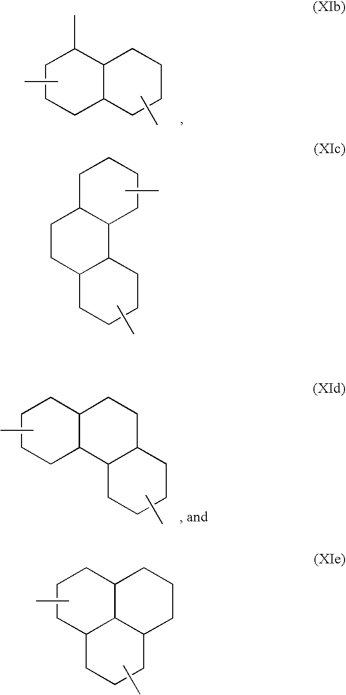

12. Composition according to claim 11 which has the structure

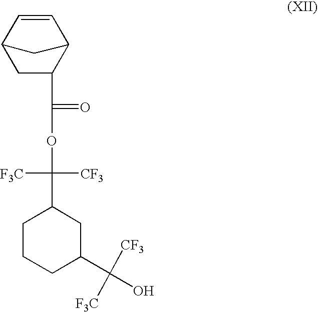

13. Composition according to claim 11 which has the structure

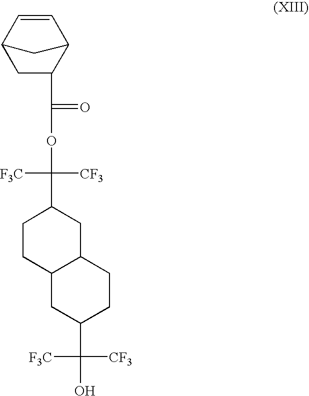

14. Composition according to claim 11 which has the structure

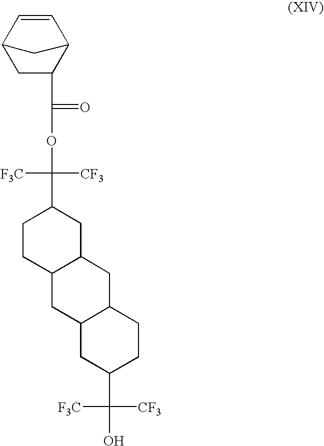

15. Composition according to claim 11 which has the structure

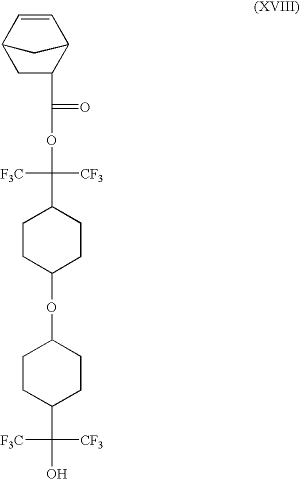

16. Composition according to claim 11 which has the structure

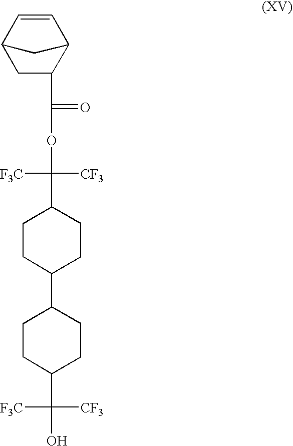

17. Composition according to claim 11 which has the structure

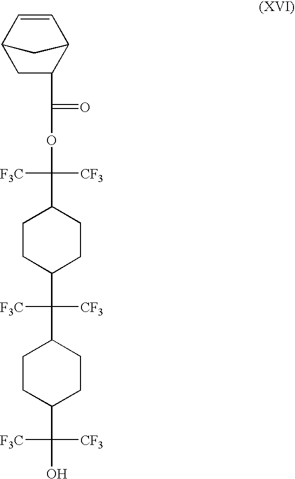

18. Low absorbing polymer at 157 nm wavelength having the structure 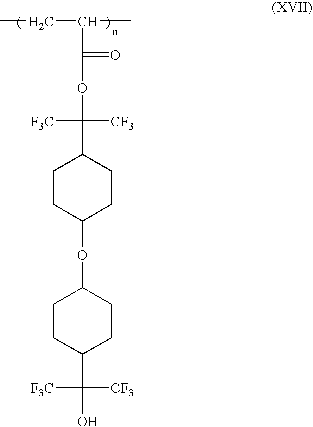
where n ranges from 4 to 30.
